(19) United States
(12) Patent Application Publication
(10) Pub. No.: US 2019/0268373 A1
(43) Pub. Date: Aug. 29, 2019

(54) SYSTEM, METHOD, APPARATUS, AND COMPUTER PROGRAM PRODUCT TO DETECT PAGE IMPERSONATION IN PHISHING ATTACKS

(71) Applicant: Mucteba Celik, Jersey City, NJ (US)

(72) Inventor: Mucteba Celik, Jersey City, NJ (US)

(21) Appl. No.: 15/904,923

(22) Filed: Feb. 26, 2018

(51) Int. Cl. H04L 29/06; H04L 29/08; H04L 12/58; G06K 9/00; G06F 17/30

(52) U.S. Cl. CPC H04L 63/1483; H04L 67/02; G06F 17/30887; G06K 9/00483; H04L 51/08

(57) ABSTRACT

A system, method, apparatus, and computer program product to detect page impersonation in phishing attacks. The system detects phishing attempts by extracting an embedded URL from an e-mail message and captures a screenshot image of the referenced site. The captured screenshot is analyzed with an image recognition module that compares the captured screenshot with a record screenshot of one or more trusted sites. If the comparison indicates that the screenshots differ, the embedded URL is marked as safe. If the comparison indicates that the screenshots are the same, the domain of the embedded URL is compared with the domain for the trusted site. When the domains differ, the e-mail is marked as a page impersonation attempt. When the domains correspond, the e-mail is marked as safe. The system includes a page impersonation database of trusted site URLs, domains, and record screenshots.

### BACKGROUND OF THE INVENTION

The present invention relates to computer security and, more particularly, to computer security systems for detecting and reducing security threats presented through phishing attempts.

In the recent years, hackers create fake login pages and they register similar domain names for the website they are trying to impersonate. The hackers then send phishing URLs to unsuspecting victims via an e-mail message. Currently there is no solution to detect these fake page impersonations and fake login pages.

As can be seen, there is a need for an improved system, method, apparatus, and computer program product that automatically detect phishing URLs that are leveraged through page impersonation attacks.

### SUMMARY OF THE INVENTION

In one aspect of the present invention, a system for detecting page impersonation in phishing attacks is disclosed. The system includes a computer having a processor and a network communication; and a program product comprising machine-readable program code for causing, when executed, the computer to perform process steps. The steps include automatically analyzing the body of an e-mail message to detect an embedded universal resource locator (URL). The embedded URL is automatically extracted and a screenshot of a website referenced by the embedded URL is captured. The captured screenshot is compared with a record screenshot, wherein the record screenshot corresponds to a trusted site. If the captured screenshot does not match the record screenshot, the embedded URL marked as safe.

If the captured screenshot matches the record screenshot, the system then determines if a domain of the embedded URL corresponds to a trusted domain. If the domain of the embedded URL corresponds to the trusted domain, the embedded URL is marked as safe. If the domain of the embedded URL does not correspond to the trusted domain, the e-mail message is marked as a page impersonation attempt.

The system may also include a page impersonation database storing data associated with the trusted site. The trusted site data includes: a trusted URL, a trusted domain corresponding to the trusted URL, and the record screenshot. The system may also receive a URL designating a contributed site from a user and the contributed site is stored in the page impersonation database. The system may then automatically capture a screenshot of the contributed site and store the screenshot for the contributed site in the page impersonation database.

Other aspects of the invention include a method for detecting a page impersonation phishing attempt presented by an e-mail message. The method includes automatically analyzing the body of an e-mail message to extract an embedded universal resource locator (URL). A screenshot of a website referenced by the embedded URL is automatically captured. The captured screenshot is then compared with a record screenshot, wherein the record screenshot corresponds with a trusted site.

If the captured screenshot does not match the record screenshot, the embedded URL is marked as safe. If the captured screenshot matches the record screenshot, the method determines if a domain of the embedded URL corresponds to a trusted domain associated with the trusted site.

If the domain of the embedded URL corresponds to the trusted domain, the embedded URL is marked as safe. If the domain of the embedded URL does not correspond to the trusted domain, the e-mail message is marked as a page impersonation attempt.

In embodiments of the invention, one or more trusted sites are stored in a page impersonation database. The stored trusted site includes a trusted URL, a trusted domain corresponding to the trusted URL, and the record screenshot. The method may also include receiving a URL designating a contributed site from a user and storing the contributed site in the page impersonation database.

The method may then automatically capture a screenshot of the contributed site and store the screenshot for the contributed site in the page impersonation database.

Yet other aspects of the invention include a non-transitory computer-readable memory adapted to detect page impersonation phishing attacks, the non-transitory computer readable memory is used to direct a computer to perform process steps. The process steps include automatically analyzing the body of an e-mail message to extract an embedded universal resource locator (URL). Automatically capturing a screenshot of a website referenced by the embedded URL and automatically comparing the captured screenshot with a record screenshot, wherein the record screenshot corresponds with a trusted site.

If the captured screenshot does not match the record screenshot, the embedded URL is marked as safe. However, if the captured screenshot matches the record screenshot, the method includes determining if a domain of the embedded URL corresponds to a trusted domain associated with the trusted site.

If the domain of the embedded URL corresponds to the trusted domain, the embedded URL is marked as safe. If the domain of the embedded URL does not correspond to the trusted domain, the e-mail message is marked as a page impersonation attempt.

Other aspects of the method include storing one or more trusted site in a page impersonation database, wherein the trusted site includes a trusted URL, a trusted domain corresponding to the trusted URL, and the record screenshot. The method may also include receiving a URL designating a contributed site from a user. A screenshot of the contributed site and the screenshot of the contributed site may be automatically stored in the page impersonation database.

These and other features, aspects and advantages of the present invention will become better understood with reference to the following drawings, description and claims.

### BRIEF DESCRIPTION OF THE DRAWINGS

FIG. 1 is a schematic view of the protected list population.

FIG. 2 is a schematic view of a typical analysis process.

FIG. 3 is a flow chart of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved system, method, apparatus, and computer program product that detects page impersonation in phishing attacks.

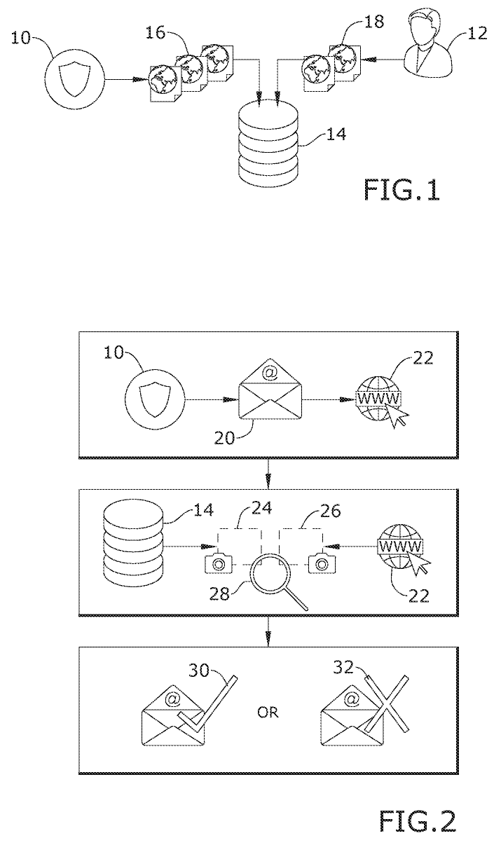

As seen in reference to FIG. 1, aspects of the invention include a security software 10, which may be included in a gateway appliance, as a plugin, or other application. The system includes a list URLs for a plurality of trusted sites 16 and their respective domains that are to be protected, which are stored in a database 14. The system captures a record screenshot 24 of the trusted sites 16 and services in advance, which is stored with the trusted list 16 in the database 14.

A user 12 may also add URLs for services and websites to the protected list, as contributed sites 18. The system is configured to capture a record screenshot of the user contributed sites 18.

As seen in reference to FIG. 2, the system 10 is configured to analyze an e-mail 20 that is received by an e-mail client the user 12. The e-mail is analyzed to detect the presence of one or more embedded URLs 22 within the body of the e-mail. The system 10 extracts the embedded URLs 22 from the e-mail for image impersonation processing.

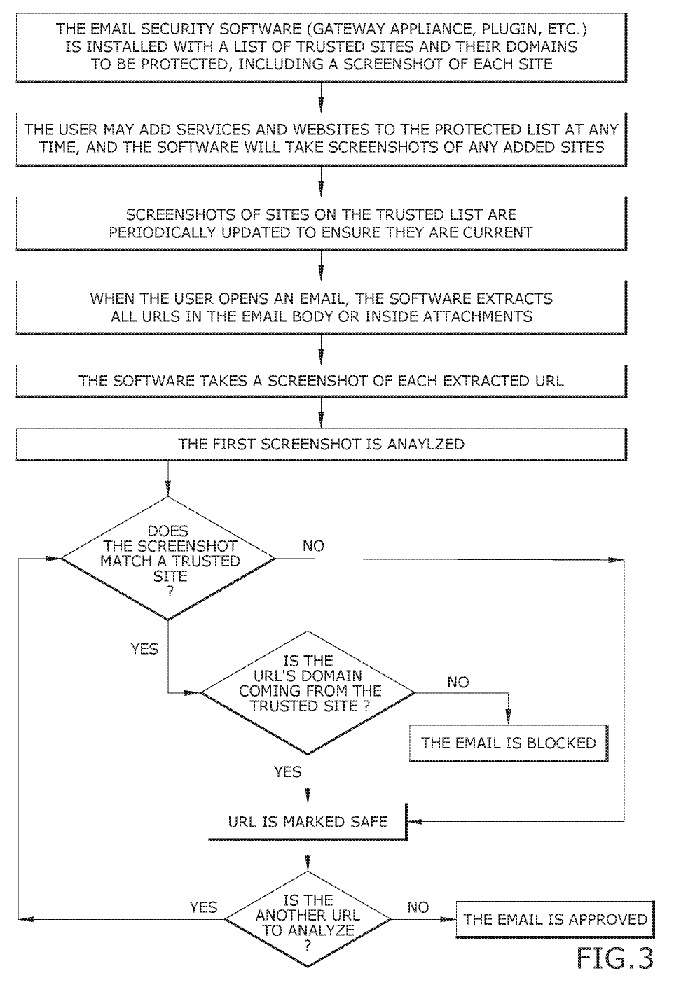

Using an image impersonation analysis engine, shown in FIG. 3, the system captures a screenshot of the site that is linked by the embedded URL 22. The extracted URL 22 is used to obtain a captured screenshot 26 for each extracted URL 22.

The image impersonation analysis engine 28 compares the captured screenshot 26 with the record screenshot 24. If the captured screenshot 26 is different from a record screenshot 24, the URL is marked as safe. If the captured screenshot 26 is the same as a record screenshot 24, the extracted URL 22 is then compared to determine if its domain is referencing a protected domain. If the domain of the extracted URL 22 is not from a protected site 16, the e-mail 20 is blocked, or otherwise marked as a phishing attempt 32. If the domain of the extracted URL 22 is the same as the corresponding domain for the matched record screenshot 24, the extracted URL 22 is marked as a safe e-mail 30.

The system then determines whether there are additional extracted URLs 22 to process. If there are additional extracted URLs to process, the process of image impersonation analysis engine 28 process is repeated. If there are no additional extracted URLs 22 to process, the image impersonation analysis engine 28 marks the e-mail as approved.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

1. A system for detecting page impersonation in phishing attacks, comprising:
a computer having a processor and a network communication; and
a program product comprising machine-readable program code for causing, when executed, the computer to perform the following process steps:
automatically analyzing the body of an e-mail message to detect an embedded universal resource locator (URL);
automatically extracting the embedded URL;
automatically capturing a screenshot of a website referenced by the embedded URL;
automatically comparing the captured screenshot with a record screenshot, wherein the record screenshot corresponds a trusted site; and
when the captured screenshot does not match the record screenshot, marking the embedded URL as safe.

2. The system of claim 1, further comprising:
when the captured screenshot matches the record screenshot, determining if a domain of the embedded URL corresponds to a trusted domain.

3. The system of claim 2, further comprising:
when the domain of the embedded URL corresponds to the trusted domain, marking the embedded URL as safe.

4. The system of claim 3, further comprising:
when the domain of the embedded URL does not correspond to the trusted domain, marking the e-mail message as a page impersonation attempt.

5. The system of claim 1, further comprising:
a page impersonation database storing data associated with the trusted site, wherein the trusted site data includes: a trusted URL, a trusted domain corresponding to the trusted URL, and the record screenshot.

6. The system of claim 5, further comprising:
receiving a URL designating a contributed site from a user; and
storing the contributed site in the page impersonation database.

7. The system of claim 6, further comprising:
automatically capturing a screenshot of the contributed site; and
storing the screenshot for the contributed site in the page impersonation database.

8. A method for detecting a page impersonation phishing attempt presented by an e-mail message, comprising:
automatically analyzing the body of an e-mail message to extract an embedded universal resource locator (URL);
automatically capturing a screenshot of a website referenced by the embedded URL;
automatically comparing the captured screenshot with a record screenshot, wherein the record screenshot corresponds with a trusted site; and
when the captured screenshot does not match the record screenshot, marking the embedded URL as safe.

9. The method of claim 8, further comprising:
when the captured screenshot matches the record screenshot, determining if a domain of the embedded URL corresponds to a trusted domain associated with the trusted site.

10. The method of claim 9, further comprising:
when the domain of the embedded URL corresponds to the trusted domain, marking the embedded URL as safe.

11. The method of claim 10, further comprising:
when the domain of the embedded URL does not correspond to the trusted domain, marking the e-mail message as a page impersonation attempt.

12. The method of claim 9, further comprising:
storing the trusted site in a page impersonation database, wherein the trusted site includes a trusted URL, a trusted domain corresponding to the trusted URL, and the record screenshot.

13. The method of claim 12, further comprising:
receiving a URL designating a contributed site from a user; and
storing the contributed site in the page impersonation database.

14. The method of claim 13, further comprising:
automatically capturing a screenshot of the contributed site; and
storing the screenshot for the contributed site in the page impersonation database.

15. A non-transitory computer-readable memory adapted to detect page impersonation phishing attacks, the non-transitory computer readable memory used to direct a computer to perform process steps, comprising:
automatically analyzing the body of an e-mail message to extract an embedded universal resource locator (URL);
automatically capturing a screenshot of a website referenced by the embedded URL;
automatically comparing the captured screenshot with a record screenshot, wherein the record screenshot corresponds with a trusted site; and
when the captured screenshot does not match the record screenshot, marking the embedded URL as safe.

16. The non-transitory computer-readable memory of claim 15, wherein the process steps further comprise:
when the captured screenshot matches the record screenshot, determining if a domain of the embedded URL corresponds to a trusted domain associated with the trusted site.

17. The non-transitory computer-readable memory of claim 9, wherein the process steps further comprise:
when the domain of the embedded URL corresponds to the trusted domain, marking the embedded URL as safe.

18. The non-transitory computer-readable memory of claim 17, wherein the process steps further comprise:
when the domain of the embedded URL does not correspond to the trusted domain, marking the e-mail message as a page impersonation attempt.

19. The non-transitory computer-readable memory of claim 18, wherein the process steps further comprise:
storing the trusted site in a page impersonation database, wherein the trusted site includes a trusted URL, a trusted domain corresponding to the trusted URL, and the record screenshot.

20. The non-transitory computer-readable memory of claim 19, wherein the process steps further comprise:
receiving a URL designating a contributed site from a user;
automatically capturing a screenshot of the contributed site; and
storing the contributed site and the screenshot of the contributed site in the page impersonation database.
